(19) United States
(12) Patent Application Publication
(10) Pub. No.: US 2023/0146424 A1
(43) Pub. Date: May 11, 2023

(54) AUTOMATIC CEMENT PLASTERING AND RENDERING SYSTEM AND OPERATION METHOD THEREOF

(71) Applicant: FENG CHIA UNIVERSITY, Taichung City (TW)

(72) Inventors: YU-TING SHENG, Taichung City (TW); SHIH-YUAN WANG, Taichung City (TW)

(21) Appl. No.: 17/585,413

(22) Filed: Jan. 26, 2022

(30) Foreign Application Priority Data
Nov. 10, 2021 (TW) 110141741

(51) Int. Cl. E04F 21/08; G06T 7/70; B25J 9/16; B25J 11/00; B25J 15/00; E04F 21/16

(52) U.S. Cl. CPC E04F 21/08; G06T 7/70; B25J 9/1697; B25J 11/0075; B25J 15/0019; B25J 9/1664; E04F 21/161; G06T 2207/10028

(57) ABSTRACT

The present invention discloses an automatic cement plastering and rendering system configured on a machine with a slurry supply apparatus and a robot, wherein the system comprises at least one image capture device, a storage, and a processor. Said processer is coupled to the at least one image capture device and the storage, and communicatively connected with the machine.

### TECHNICAL FIELD

The present invention relates to a cement plastering and rendering system and its operation method, especially an automatic cement plastering and rendering system and operation method thereof in cooperation with a robot.

### BACKGROUND OF RELATED ARTS

In the general cement plastering and rendering method, the main manner is to coat a layer of cement material on the wall to be constructed and use a tool (such as a trowel) to scrape the cement material to make it level before the cement material is dry. However, if the irregular gaps (or openings) on the wall are not filled with the cement material during coating and scraping, the unmodified gaps will appear concave after the cement material dries, such that the wall is difficult to level, which affects the appearance of the finished product.

However, it is common to use construction methods to solve this problem, the current methods are not only time-consuming and labor-intensive, but also heavily depend on the skill of the solid plasterer. In this regard, how to make the wall appear even in an automated and fast state is substantially what the industry requires.

### SUMMARY

In order to solve at least one of the above-mentioned problems, some embodiments of the present invention provide a cement plastering and rendering system and an operation method thereof, especially an automatic cement plastering and rendering system and an operation method that cooperate with a robot. Specifically, the automatic cement plastering and rendering system utilizes the coordinate transformation of point cloud coordinates in different coordinate systems to control the actions of the slurry supply apparatus and robot during the spraying and finish of cement materials, so as to perform a plastering more effectively over a large area of wall, and thus the working hours are greatly shortened.

At least one embodiment of the present invention is an automatic cement plastering and rendering system configured in a machine with a slurry supply apparatus and a robot. The system includes at least one image capture device, a storage and a processor. The processor is connected to the image capture device and the storage and thus to realize the communication of the connection between the machine and the processor.

At least one embodiment of the present invention is an operation method of an automatic cement plastering and rendering system. The operation method comprises the following steps: provide the previously mentioned automatic cement plastering and rendering system. Produce a plurality of point cloud coordinates in the first coordinate system according to the at least one image acquired by the at least one image capture device. Perform coordinate transformation on the point cloud coordinates according to the at least one transfer matrix, so that the point cloud coordinates are transformed from the first coordinate system corresponding to the at least one image to the second coordinate system corresponding to the slurry supply apparatus, and again transform the point cloud coordinates from the second coordinate system corresponding to the slurry supply apparatus to the third coordinate system corresponding to the robot according to the at least one transfer matrix, and individually store the second coordinate system and the third coordinate system comprising the point cloud coordinates respectively. Control movement of the slurry supply apparatus according to the second coordinate system in the storage, so that the slurry supply apparatus is used to perform the spraying on the wall as a nozzle of the slurry supply apparatus is at a certain distance from the wall. Moreover, following the spraying, control movement of the robot according to the third coordinate system of the storage, so that the tool performs a plastering or rendering on the wall based on a predetermined path.

Embodiments of the invention are illustrated by way of example, and not by way of limitation, in the figures of the accompanying drawings in which like reference numerals refer to similar elements.

### BRIEF DESCRIPTION OF THE DRAWINGS

FIG. 1 illustrates a schematic diagram of the automatic cement plastering and rendering system of the present invention.

FIG. 2 illustrates a flow chart of the operation method of the automatic cement plastering and rendering system of the present invention.

### DETAILED DESCRIPTION OF THE INVENTION

In order to understand the technical features and practical efficacy of the present invention and to implement it in accordance with the contents of the specification, hereinafter, preferred embodiments of the present invention will be described in detail with reference to the accompanying drawings.

At least one embodiment of the present invention relates to a cement plastering system and its operating method thereof, especially an automatic cement plastering and rendering system that cooperates with a robot and its operating method.

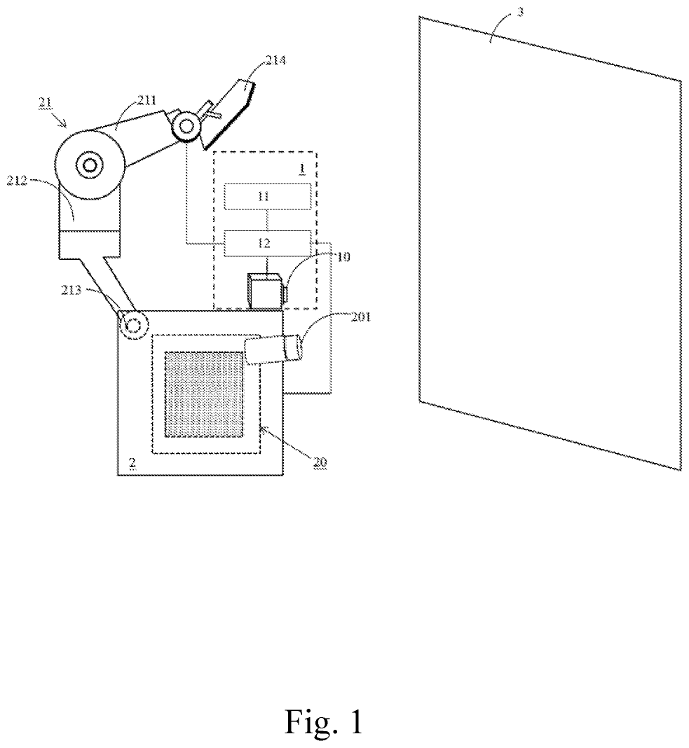

FIG. 1 is a schematic diagram of the automatic cement plastering and rendering system of the present invention. In FIG. 1, the automatic cement plastering and rendering system 1 includes at least one image capture device 10, a storage 11, and a processor 12, and the processor 12 is connected to the image capture device 10 and the storage 11, so that a plurality of point cloud coordinates can be obtained by the image capture device 10 and processed by the processor 12.

The automatic cement plastering and rendering system 1 is configured in a machine 2. The machine 2 is equipped with at least a robot 21 and a slurry supply apparatus 20 and is connected to the processor 12 through communication. In this embodiment, the robot 21 may include any kind of machine elements or the like and may be connected to operating equipment such as an arm, a nozzle 201, a sprayer, or a combination thereof as appropriate. In one aspect (please refer to FIG. 1), the robot 21 can be a robotic arm, which has at least one upper arm 211, at least one lower arm 212, and a retainer 213. The upper arm is configured at one end of the lower arm and mounted with at least one tool 214. Otherwise, the retainer 213 is configured at the other end of the lower arm 212 to connect with the machine 2. In this case, the at least one tool 214 can be a workpiece such as a trowel (spatula) or the like, which can be controlled by the robot 21 with a robot arm.

In this embodiment, the slurry supply apparatus 20 may also be any device used in spraying application to spray the cement material toward a wall 3 through a nozzle 201 provided therein (i.e., by using a S-shaped filling method for spraying).

The feature of this embodiment is that by establishing a coordinate transformation relation between a first coordinate system of the image capture device 10, a second coordinate system of the slurry supply apparatus 20, and a third coordinate system of the robot 21 (i.e., the coordinates of a certain feature in one coordinate system are converted to the coordinates of another coordinate system) to conduct the spraying as well as the plastering and rendering of the wall 3.

Specifically, in this embodiment, it is assumed that the first coordinate system is an orthogonal coordinate system with the image capture device 10 as the origin, and the second coordinate system is an orthogonal coordinate system with the nozzle 201 of the slurry supply apparatus 20 as the origin, and the third coordinate system is an orthogonal coordinate system with tool 214 of robot 21 as the origin. Since the positional relationship of the image capture device 10, the nozzle 201 and the tool 214 is fixed, the coordinate transformation from the first coordinate system to the second coordinate system and the second coordinate system to the third coordinate system can be controlled with higher precision. And, under this assumption, the image capture device 10 can be configured on the slurry supply apparatus 20 or on a location other than the slurry supply apparatus 20 and execute the coordinate transformation of multiple point cloud coordinates in the first coordinate system by using at least one transfer matrix stored in the storage 11.

The image capture device 10 of FIG. 1 may be a color camera or a gray scale camera coupled with a depth sensor, which is configured to capture at least one image in a scene and a plurality of depths. Specifically, the scene includes at least two border lines that allow the processor 12 to recognize the size of the wall 3. Therefore, when generating a plurality of point cloud coordinates, the processor 12 can: determine a plurality of pixel coordinates in the image; input the depth into the pixel coordinates and perform matching to obtain a plurality of point cloud coordinates in the first coordinate system. Certainly, the image capture device 10 may also be a depth camera such as a time-of-flight (ToF) depth camera, an RGB-D camera, and a structured light three-dimensional scanning camera, which is not limited by the present invention.

Storage 11 can store information of processor 12 during operation or programs and functions during execution. In this embodiment, storage 11 can be configured to store and provide any type of long-term memory, short-term memory, long-term short-term memory (LSTM), volatile memory, non-volatile memory, or any computer-readable media of the image and the transfer matrix. The transfer matrix records the coordinate transformation relation between the first coordinate system and the second coordinate system, as well as the second coordinate system and the third coordinate system. In one aspect, storage 11 may be a part of the processor 12, but it should be noted that the storage 11 may also be independent of the processor 12.

The processor 12 may be a conventional processor used by people in the field, including a central processor (Central Processing Unit, CPU), a digital signal processor (Digital Signal Processor, DSP), a microprocessor (Micro Processing Unit, MPU), a microcontroller (Micro Control Unit, MCU) and its combination, etc.

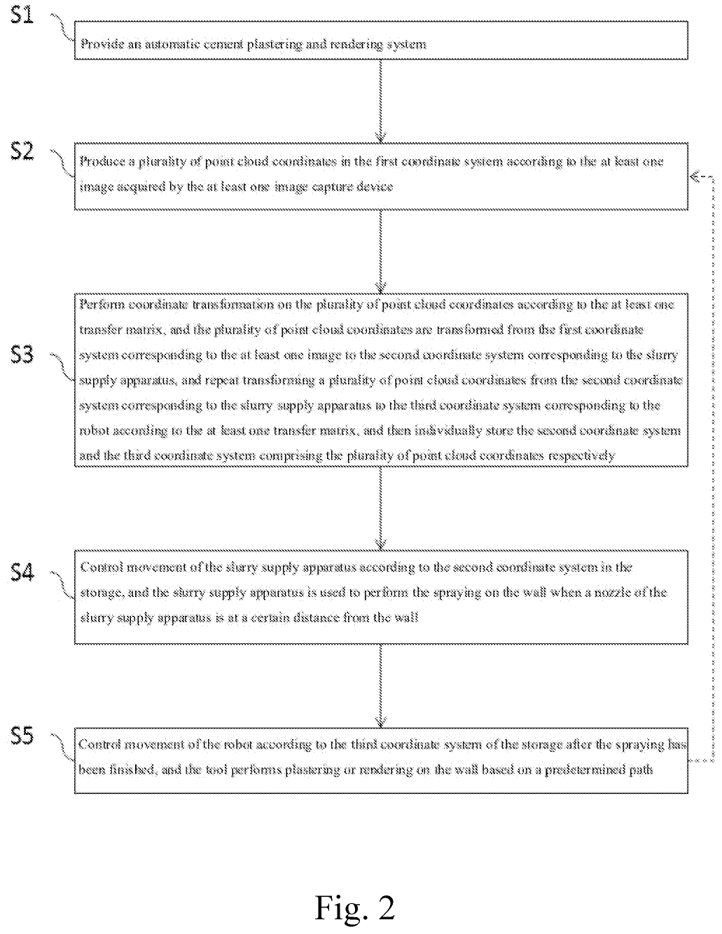

FIG. 2 is a flowchart showing the operation method of the automatic cement plastering and rendering system 1 of the present invention. In this embodiment, first, the processor 12 controls the image capture device 10 to capture an image containing at least two border lines from the scene and generate the plurality of point cloud coordinates according to the image (step S2). Afterwards, the processor 12 controls the movement of the slurry supply apparatus 20 so that the nozzle 201 is positioned at a certain distance in front of the wall 3 and allows the slurry supply apparatus 20 to move while determining the position of the wall 3 coordinates in the second coordinate system and the third coordinate system (step S3). Under the abovementioned condition, the supply apparatus 20 performs a spraying action to cover the cement material on the wall 3 (step S4) and stops the spraying action when it is determined that the predetermined time has passed (or the predetermined supply amount has been reached). Next, by positioning the tool 214 of the robot 21 in front of the wall 3, the tool 214 performs plastering and rendering on the wall 3 along a predetermined path as shown in FIG. 3 to generate a flat wall 3 (step S5). As shown in FIG. 2, these steps can also be repeated until the entire wall 3 is painted.

The value of said certain distance in front of the wall 3 can be set according to the requirements, and the present invention is not limited. (For instance, if you want to spray a larger area of wall 3, you can set a larger value.)

Preferably, in order to accurately fill the uneven parts of wall 3 (e.g., dents or bulges), the preceding process from spraying action to plastering and rendering or the process of solely plastering and rendering is preferably performed multiple times so that the wall 3 becomes more leveled. In detail, after step S3 ends, the processor 12 can then determine whether there is at least one identifiable target coordinate in the wall 3 coordinates of the second coordinate system. In addition, when the result of the determination is “Yes”, the specific target coordinates are marked and recorded to indicate the uneven parts of the wall 3 that requires to be repeatedly executed step S4, or else, step S4 and step S5 thereon. For example, if the processor 12 recognizes that the distance value from a point cloud coordinate to the nozzle 201 (the origin of the second coordinate system) is greater than a threshold value, it is determined that said point cloud coordinates belong to the target coordinates that need to be repeated in step S5; otherwise, if the processor 12 identifies the value of the distance from a point cloud point to the nozzle 201 (the origin of the second coordinate system) is less than a threshold value, it is determined that the point cloud coordinates belong to the target coordinates that require repeated execution of step S4 and step S5. Herein, the threshold value may be a median, a mean, or a mode of the distance values, depending on the actual requirements.

Further, in the present embodiment, the processor 12 may also determine the number of times that the process of the spraying action to the plastering and rendering or merely the process of the plastering and rendering needs to be repeated based on the difference between each of the distance values and said threshold value. For example, once the difference is determined to be N times a predetermined value, it is determined that the target coordinate regarding said difference is an uneven part that needs to be repeated N times (steps S4 and S5, or step S5). If the difference is a positive value, the step that requires to be repeated is step S5; otherwise, if the difference is a negative value, the step that requires to be repeated is step S4 and S5. However, because the number of N shall be an integer, when the quotient of the difference and the predetermined value is not an integer, the value of N is equal to the result of rounding the quotient up/down.

It is a noteworthy fact that the abovementioned steps shall include the process of converting the coordinate of the target coordinates in the second coordinate system to the coordinates of the third coordinate system such that the target coordinates of step S4 could be identified in step S5.

In addition, the processor 12 can also pre-position the nozzle 201 of the slurry supply apparatus 20 at a specific spraying start position, and then perform the spraying on the wall 3 according to a set movement path (S-shaped/or Z-shaped). Also, since the start position of the spraying action is the known coordinate in the second coordinate system, during actual execution, the processor 12 can control the movement of the robot 21 based on the positional relation between the nozzle 201 and the tool 214. Accordingly, the set positional relation serves as a guide that directs the tool 214 to the position of the nozzle 201, and thereafter acts as the starting position of the plastering and rendering. Said starting position of the spraying action may be any position on the wall 3, which is not limited by the present invention.

As is understood by a person skilled in the art, the foregoing preferred than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. An automatic cement plastering and rendering system, configured in a machine which comprises a slurry supply apparatus and a robot;
wherein the automatic cement plastering and rendering system comprises:
at least one image capture device, configured to capture at least one image of at least a portion of a wall comprised in a scene;
a storage, configured to store the at least one image and at least one transfer matrix; and
a processor, connected to the image capture device and the storage, and realized the communication of the connection between the machine and the processor;
wherein the processor is configured to: receiving the at least one image, and generating a plurality of point cloud coordinates based on the at least one image;
controlling the slurry supply apparatus to conduct a spraying based on an outcome of converting the plurality of point cloud coordinates from a first coordinate system to a second coordinate system according to the at least one transfer matrix, and controlling the robot to perform a plastering and rendering based on an outcome of converting the plurality of point cloud coordinates from a second coordinate system to a third coordinate system according to the at least one transfer matrix.

2. The automatic cement plastering and rendering system as claimed in claim 1, wherein the slurry supply apparatus comprises a nozzle.

3. The automatic cement plastering and rendering system as claimed in claim 1, wherein the robot comprises at least one upper arm, at least one lower arm and a retainer, and two ends of the at least one lower arm are individually connected to the at least one upper arm and the retainer respectively.

4. The automatic cement plastering and rendering system as claimed in claim 1, wherein the at least one image comprises at least two border lines of the wall.

5. The automatic cement plastering and rendering system as claimed in claim 3, wherein the at least one upper arm further comprises at least one tool, and the at least one tool is a trowel or a spatula.

6. An operating method of an automatic cement plastering and rendering system, comprising the following steps:
S1. providing an automatic cement plastering and rendering system as claimed in claim 1;
S2. producing a plurality of point cloud coordinates in the first coordinate system according to the at least one image acquired by the at least one image capture device;
S3. performing coordinate transformation on the plurality of point cloud coordinates according to the at least one transfer matrix, and the plurality of point cloud coordinates are transformed from the first coordinate system which is corresponding to the at least one image to the second coordinate system which is corresponding to the slurry supply apparatus, and repeating transforming a plurality of point cloud coordinates from the second coordinate system which is corresponding to the slurry supply apparatus to the third coordinate system which is corresponding to the robot according to the at least one transfer matrix, and then individually storing the second coordinate system and the third coordinate system which comprises the plurality of point cloud coordinates respectively;
S4. controlling movement of the slurry supply apparatus according to the second coordinate system in the storage, and the slurry supply apparatus is used to perform the spraying on the wall when a nozzle of the slurry supply apparatus is at a certain distance from the wall; and
S5. controlling movement of the robot according to the third coordinate system of the storage after the spraying has been finished, and the tool performs plastering and rendering on the wall based on a predetermined path.

7. The operating method of an automatic cement plastering and rendering system as claimed in claim 6, wherein there is a sub-step after the step S3 and prior to the step S4 further comprising:
determining distance values from each point cloud coordinate in the second coordinate system to an origin;
determining whether each of the distance values is greater than or less than a threshold value; and
confirming each of the distance values is greater than or less than the threshold value, and storing and recording each point cloud coordinate as a target coordinate.

8. The operating method of an automatic cement plastering and rendering system as claimed in claim 6, wherein the step S4 further comprises: before performing the spraying, firstly shifting the nozzle of the slurry supply apparatus to a spraying start position; and then spraying the wall from the spraying start position according to a set movement path.

9. The operating method of an automatic cement plastering and rendering system as claimed in claim 7, wherein the threshold value is a median, a mean or a mode of the distance values.

10. The operating method of an automatic cement plastering and rendering system as claimed in claim 8, wherein the set movement path is S shape or Z shape.
